(19) United States
(12) Patent Application Publication
(10) Pub. No.: US 2017/0171271 A1
(43) Pub. Date: Jun. 15, 2017

(54) VIDEO STREAMING

(71) Applicant: International Business Machines Corporation, Armonk, NY (US)

(72) Inventors: Alexander J. Kelly, ROMSEY (GB); Alexander D.S. Mirski-Fitton, HURSLEY (GB); Edwin P.J. Moffatt, HURSLEY (GB); Ross B. Pavitt, HURSLEY (GB)

(21) Appl. No.: 14/963,558

(22) Filed: Dec. 9, 2015

(51) Int. Cl. H04L 29/06; H04L 29/08

(52) U.S. Cl. CPC H04L 65/60; H04L 67/303

(57) ABSTRACT

A computer implemented method comprising storing a plurality of client profiles, each client profile defining one or more areas of importance for a frame of a video stream, transmitting a video stream to a plurality of clients, determining that a connection to a specific client comprises insufficient bandwidth to transmit the video stream at full resolution, accessing a client profile for the specific client with a connection of insufficient bandwidth, reducing the data rate of one or more areas of the frames of the video stream that are not defined as areas of importance for a frame of the video stream in the accessed client profile for the specific client with a connection of insufficient bandwidth, and transmitting the reduced data rate frames to the specific client with a connection of insufficient bandwidth.

### BACKGROUND

The present invention relates to a method and system for transmitting a video streaming to a plurality of clients. Video streaming is widely used on the Internet to transmit live video simultaneously from a server to multiple clients.

### SUMMARY

According to a first aspect of the present invention, there is provided a computer implemented method comprising storing a plurality of client profiles, each client profile defining one or more areas of importance for a frame of a video stream, transmitting a video stream to a plurality of clients, determining that a connection to a specific client comprises insufficient bandwidth to transmit the video stream at full resolution, accessing a client profile for the specific client with a connection of insufficient bandwidth, reducing the data rate of one or more areas of the frames of the video stream that are not defined as areas of importance for a frame of the video stream in the accessed client profile for the specific client with a connection of insufficient bandwidth, and transmitting the reduced data rate frames to the specific client with a connection of insufficient bandwidth.

According to a second aspect of the present invention, there is provided a system comprising a storage device arranged to store a plurality of client profiles, each client profile defining one or more areas of importance for a frame of a video stream, and a processor arranged to transmit a video stream to a plurality of clients, determine that a connection to a specific client comprises insufficient bandwidth to transmit the video stream at full resolution, access a client profile for the specific client with a connection of insufficient bandwidth, reduce the data rate of one or more areas of the frames of the video stream that are not defined as areas of importance for a frame of the video stream in the accessed client profile for the specific client with a connection of insufficient bandwidth, and transmit the reduced data rate frames to the specific client with a connection of insufficient bandwidth.

According to a third aspect of the present invention, there is provided a computer program product for controlling a system, the computer program product comprising a computer readable storage medium having program instructions embodied therewith, the program instructions executable by a processor to cause the processor to access a plurality of stored client profiles, each client profile defining one or more areas of importance for a frame of a video stream, transmit a video stream to a plurality of clients, determine that a connection to a specific client comprises insufficient bandwidth to transmit the video stream at full resolution, access a client profile for the specific client with a connection of insufficient bandwidth, reduce the data rate of one or more areas of the frames of the video stream that are not defined as areas of importance for a frame of the video stream in the accessed client profile for the specific client with a connection of insufficient bandwidth, and transmit the reduced data rate frames to the specific client with a connection of insufficient bandwidth.

### BRIEF DESCRIPTION OF THE DRAWINGS

Embodiments of the present invention will now be described, by way of example only, with reference to the following drawings, in which:

FIG. 1 is a schematic diagram of a server connected to multiple client devices,

FIG. 2 is a schematic diagram of the server and multiple profiles,

FIG. 3 is a schematic diagram of components the server,

FIG. 4 is a flowchart of a method of performing video streaming, and

FIG. 5 is a schematic diagram of a frame of a video stream, and

FIG. 6 is a schematic diagram of a client device and a user.

### DETAILED DESCRIPTION

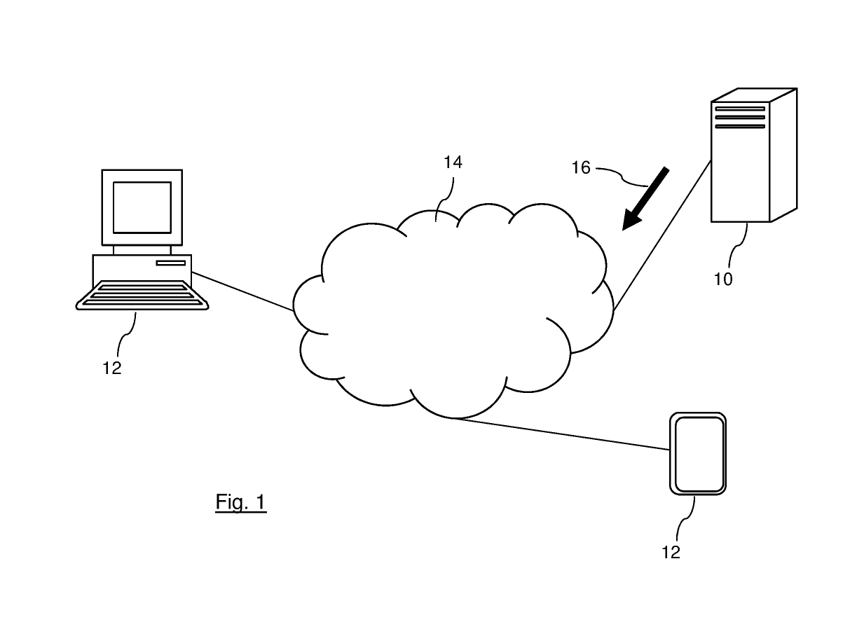

FIG. 1 shows a server 10 that is connected to a plurality of client devices 12 over a wide area network 14, such as the Internet. A video stream 16 is transmitted live to each of the connected clients 12. For example, the server 10 may be hosting a computer games tournament that supports a small number of professional computer game players, which is live streamed to other users who wish to watch the game play as the tournament unfolds. At the server 10, the video stream 16 is encoded and transmitted to each of the client devices 12, over the network 14. Depending upon the capability of the server 10 and the associated network connections, large numbers of client devices 12 can be supported, running into the many thousands of simultaneously connected client devices 12.

Depending upon a variety of factors such as the size of the individual frames that make up the video stream and the frame rate (number of frames per second), a specific bandwidth is required to receive a video stream at full resolution. Often the determining factor in whether the video stream can be received at full resolution is the final connection within the network to the specific client device 12 in question. For example, a client device 12 may be a smartphone that is connecting to the Internet over a wireless 3G network, which may not support a connection that has sufficient bandwidth for the current bitrate of the video stream 16.

Similarly, an end user may have a client device 12 that is located in a geographically remote location that has a poor quality Internet connection that cannot reliably support sufficient bandwidth to receive the video stream 16 at full bandwidth. If this is the case then the live video stream 16 will be disrupted, for example by frames being dropped so that the frame rate reduces and/or the video stream 16 freezing on a particular frame while the video stream 16 is buffered or the bandwidth is returned to a more acceptable level. This is especially true if the video stream 16 is high-definition and a 1 MB or greater bandwidth connection is required to carry the full bandwidth of the video stream 16.

In this context, bandwidth-limited, livestreaming of content, such as video games on Twitch.tv, can be a frustrating experience for the end user. In a complex game, the user can find that they are unable to discern what is going on if the video quality is too low. In the case of a video game, depending on a viewer's experience, the end user may consume a stream differently. For example, a player who is just starting out and keen to learn, may be most interested in watching the part of the screen that shows which play choices the streamer is making such as which moves they use and which upgrades they choose. Meanwhile, a more experienced player, or anyone who watches the stream purely to enjoy the action rather than to learn, would care significantly less about these areas of the screen. Currently, during streaming through a service like Twitch.tv, all parts of the screen are given the same importance. This can result in the quality of everything on screen being reduced in a situation where bandwidth is limited.

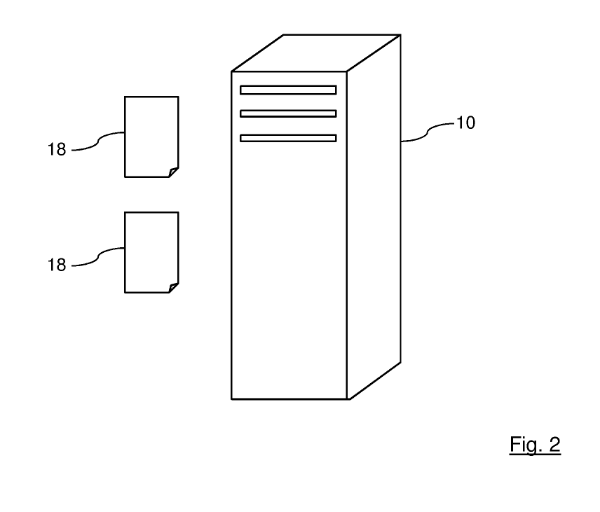

The server 10 stores a set of viewer-type profiles 18, as shown in FIG. 2. In the example of an online game, some of the types of users could be “professional player”, “eSports spectator” and “beginner player”. The server 10 identifies for each viewer which of the viewer-type profiles 18 they fit most closely, and then uses this to customise the way content is compressed if there is such a need when content is sent to the end user. For example, if two viewers' bandwidth were to drop at the same time, rather than compressing the whole video for both of them, one of them might see the top half of the screen become compressed and the lower half stay in high quality, whilst the other would see the top stay high quality and the bottom compress. By understanding the areas of the stream in which a viewer is interested, the server 10 can intelligently compress parts of the video stream 16 and not others to fit within bandwidth restrictions, but still give the end user a decent experience of watching the video stream 16 in the way that they want.

The more groups that are defined by respective profiles 18, the more tailored the solution will be to the individual end users, but at the same time the more load this will place on the server 10. In a simplified embodiment relating to the broadcast of a live computer game session, the server can use two different groups. The first group can be categorised as “eSports Spectators”, who in general do not care about the HUD (Heads Up Display) parts of the video stream 16 being shown on their screen and just want to watch the characters fighting in the middle of the screen with the relevant action such as explosions and the like. A second group can be categorised as “Beginner Players” who find all the explosions and particles in the middle of the screen confusing and prefer to focus on the bar at the bottom of the video stream which shows the abilities that the streaming player is using, as well as the area where upgrade choices are shown.

The server 10 has to create or receive the client profiles 18. These profiles 18 are stored on the server 10, and they could be manually defined or learnt by tracking viewers' eyes whilst watching other similar video streams and thereby forming profiles 18 based around the characteristics of the largest clusters of similar viewing-styles. Creating the profiles 18 could be a one-off task or, if it is possible to continue collecting data about how people are watching the stream 16, updated over time to continue to match the most popular viewing styles. The server 10 must also assign viewer-type profiles to viewers or more specifically to their client devices 12. This could be done either by getting the user to make a selection or by monitoring their viewing patterns for example to see to which viewer-type profile 18 their viewing history is most similar, for example.

Using the example of just two viewer-type groups, consider a situation relating to two different end users, where one is an “eSports Spectator” and one is a “Beginner Player”. Both end users have insufficient bandwidth to watch the full livestream at high quality, and so some compression is needed. The viewer profiles needed have already been built, and the server 10 matches the two viewers to different profiles 18, as discussed above. Whilst watching the video stream 16, the server 10 chooses to compress parts of the end user's individual streams to optimise their viewing within the bandwidth constraints.

The operation of the server 10 can be summarised by the following pseudo-code:

```
ImportantAreas = [setOfPointsOnScreen]
NonImportantAreas = [setOfPointsOnScreen]
#Note: union of those 2 sets is the whole screen
while (bandwidthInsufficient) {
      let i = 0;
      while i < 2 {
            NonImportantAreas.Compress( );
            if (bandwidthInsufficient = FALSE) then exit;
            i++
            }
      ImportantAreas.Compress( );
}
outputStream( );
```

Therefore, whenever bandwidth is too low, the server 10 will try compressing the unimportant areas twice, then if that has not worked the server 10 will try compressing the important areas. If that still does not work, the server 10 will try again. The result is that quality of unimportant areas deteriorates a lot faster in response to bandwidth constraints than the quality of important areas.

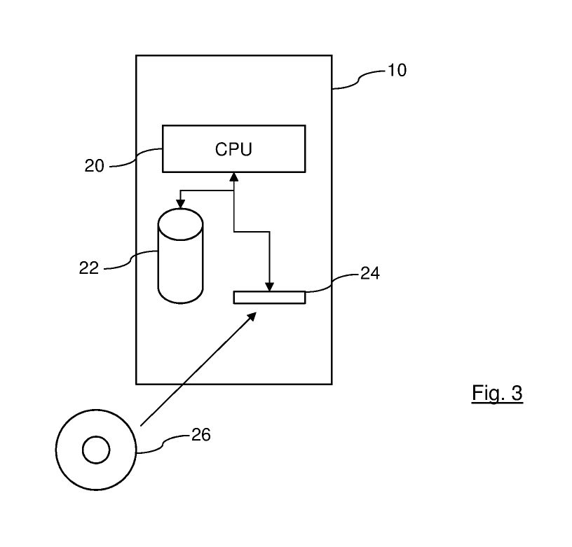

FIG. 3 shows a more detailed view of the server 10. The server is a system which comprises a processor 20, a storage device 22 connected to the processor 20 and a disk interface 24 also connected to the processor 20. Only these components are shown for ease of understanding, obviously further components would be present such as a network interface and a power supply, for example. A computer readable medium 26 is provided, which is a CD-ROM 26, which stores a computer program product for controlling the operation of the processor 20. The computer program product comprises instructions that are executed by the processor 20 in order to operate the server 10, for example according to the algorithm listed above.

The processor 20 is responsible for the video streaming to the connected client devices 12. The processor 20 is also responsible for detecting that a connection to a client device 12 does not have sufficient bandwidth to transmit the video stream 16 at full resolution. This detection can take the form of receiving a message from the client device 12 stating a maximum possible resolution that can be currently supported. If this is below the required bandwidth for the video stream 16, then the processor will need to perform some form of compression for the video stream 16 that is sent to that client device 12. This will require reducing of the data rate in those parts of a frame of the video stream 16 that have lower importance.

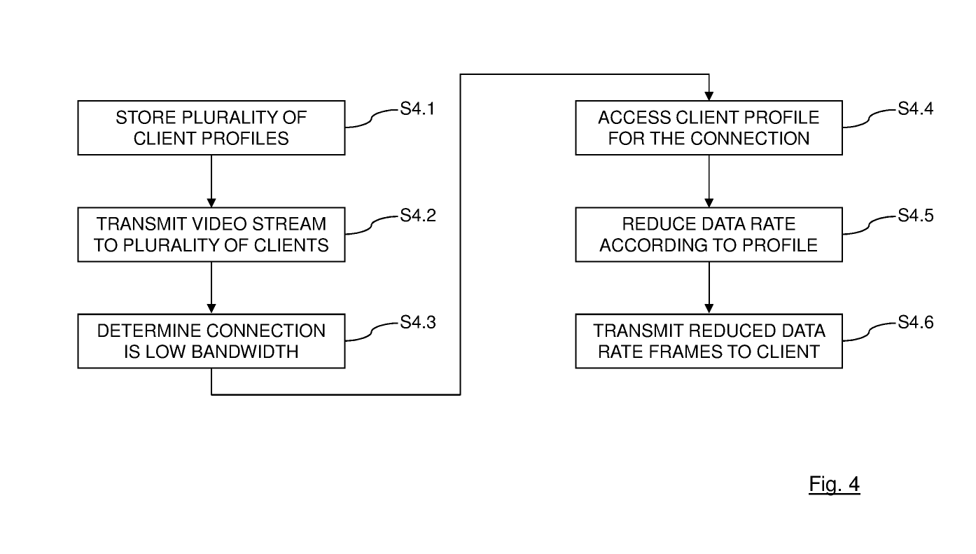

FIG. 4 is a flowchart summarising the process carried out by the server 10. The method comprises step S4.1 storing a plurality of client profiles 18, each client profile 18 defining one or more areas of importance for a frame of a video stream 16, step S4.2 transmitting a video stream 16 to a plurality of clients 12, step S4.3 determining that a connection to a specific client 12 comprises insufficient bandwidth to transmit the video stream 16 at full resolution, step S4.4 accessing a client profile 18 for the specific client 12 with a connection of insufficient bandwidth, step S4.5 reducing the data rate of one or more areas of the frames of the video stream 16 that are not defined as areas of importance for a frame of the video stream in the accessed client profile 18 for the specific client 12 with a connection of insufficient bandwidth, and step S4.6 transmitting the reduced data rate frames to the specific client 12 with a connection of insufficient bandwidth.

In this way, the profile 18 determines which parts of the frame have a reduced data rate applied to them. For example, the frame of the video stream 16, in the context of a live computer game video stream 16, may comprise an area that is a fast moving display of the current game play and also may comprise an area that contains information about a specific player in the game, such as which weapons they are using and which upgrades are selected and so on. Different users will have different interests in different parts of the frame as represented on their local screen. This is reflected in the different profiles 18 stored by the server 10.

Each profile 18 defines one or more areas of importance for a frame of the video stream 16. In the simplest embodiment of the system, the server 10 stored just two profiles, one which defines the area of importance as the fast moving display of the current game play and the other which defines the area of importance as the information part of the frame which includes details of current status and actions taken with respect to a specific player within the game. Once the bandwidth to a specific end user is too low, then the profile 18 for that user will be used to reduce the data rate in areas of the frame that are not defined as areas of importance.

The reducing of the data rate of one or more areas of the frames of the video stream 16 that are not defined as areas of importance for a frame of the video stream 16 in the accessed client profile 18 for the specific client 12 who has a connection of insufficient bandwidth, includes reducing the data rate to zero in the one or more areas of the frames of the video stream that are not defined as areas of importance for a frame of the video stream 16 in the accessed client profile 18. In this situation, parts of the frame that are not important are simply not sent to the end user or sent as empty depending upon the video coding being used.

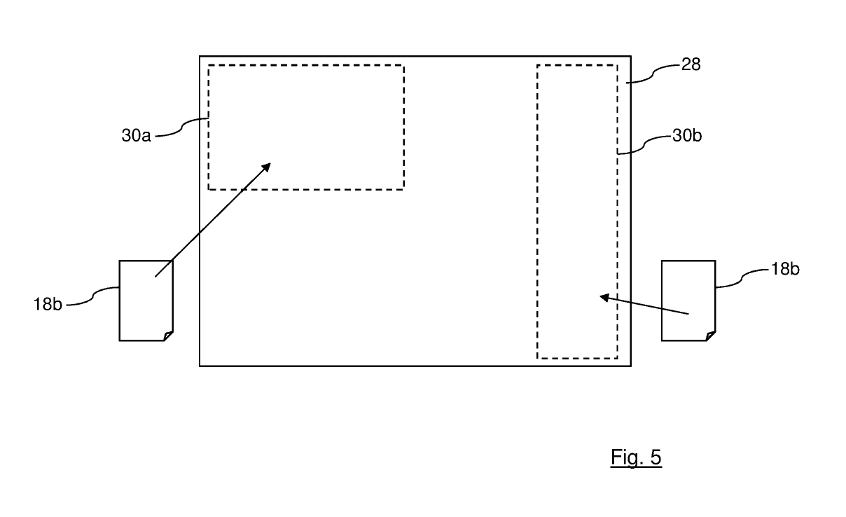

FIG. 5 illustrates a single frame 28 which has two areas of importance 30a and 30b defined with respect to two different profiles 18a and 18b. In this example, each profile 18 has a single rectangular area of importance 30 defined therefor. A profile 18 can have any number of areas of importance defined therein, and each area does not need to be rectangular, but this is a simple way in which a profile 18 can be defined. Each profile 18 can be defined, in one embodiment, by a name, an associated description explaining to whom the profile is intended to suit, an integer value defining the number of areas of importance 30 within the profile and then for each area 30, a pair of x,y co-ordinates defining opposite corners of the rectangle. Other techniques for defining the areas 30 can be used, for using polygon definitions or HTML image maps.

Using this method of defining a profile 18, then the specific profile 18a shown in FIG. 5, would be defined as follows: “eSports Spectator”, “A viewer interested in the main action”, 1, [0,0] [200,200]. Here the integer value 1 defines that there is only a single area of importance 30 within the profile 18 and the two co-ordinates define the top left and bottom right co-ordinates of the single rectangle that makes up the area of importance 30, here using an x,y co-ordinate system that has the origin 0,0 at the top left hand corner of the frame 28. The server 10 stores this profile 18a and uses the information within the profile 18a to reduce the data rate of the other parts of the frame 28 when the bandwidth is too low to support the full resolution of the frame 28.

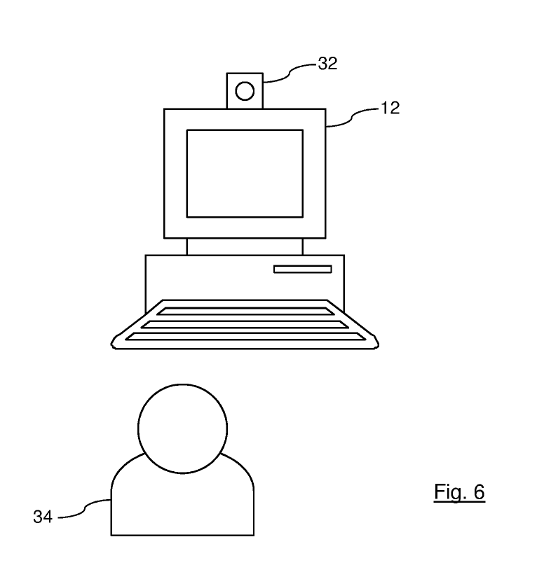

FIG. 6 shows an extension of the system which uses a feedback mechanism from the end user's client device 12. The end user's client device 12 is equipped with a camera 32 that is able to detect the eye movements of the user 34. The user's computer 12 can therefore track the user's eyes and other reactions as they watch the streamed content, and the server 10 is able to maintain an individual profile 18 for every user 34 that is constantly updated based on the user's interaction with the service. Information travels back from the client device 12 to the server 10 about the user's interaction with the streamed content 16.

In one implementation, the user's screen could be considered to be split into a small number of different zones, such as two or four, and the amount of time that the user 34 spends looking at the different zones can be monitored and measured. If the user 34 does spend more than an average amount of time looking directly at one zone of the screen, then this zone will be used to define the area 30 of importance to that specific user 34. This is then recorded as a profile 18 for that specific user 34. Such a profile 18 can be updated at any time, especially if the user's viewing habits should change. A user specific profile 18 can also be seeded from known profiles. For example, if the server 10 knows that the top left corner of a frame 28 is a stats area, then if the user 34 identifies themselves as beginner then they would have the stats section in the top left be considered important, but a stats box in the bottom right is not an area of importance, because that user does not view that stat group as much.

The server 10 can be configured to receive information defining an area 30 of importance for a frame 28 of the video stream 16 as defined by a client 12 and then select a client profile 18 for the client 12 according to a best match of the client profile 18 defining one or more areas 30 of importance for a frame 28 of a video stream 16 to the received information defining an area 30 of importance for a frame 28 of the video stream 16. In this case, rather than defining a new profile 18 based upon the information that is fed back by the client device 12, the information is used to match as closely as possible to an existing profile 18.

If the client device 12 does not have any feedback mechanism, then the server 12 can select a profile 18 to use by outputting a set of choices, each choice connected to a stored profile 18 and then receive a user input from a specific client 12 selecting a choice from the outputted set of choices and store an identification of the stored profile 18 connected to the selected choice for the specific client 12. The server 10 supplies to the client device 12 a list of available profiles 18 and the user 34 selects which one they consider to be most relevant for their desired interaction with the content being delivered by the video stream 16. This information is stored by the server 12.

The server 12 uses the stored profiles 18 to lower the data rate of the video stream 16, when the server 12 determines that a connection to a client device 12 has insufficient bandwidth to transmit the video stream 16 at full resolution. A profile 18 defines one or more areas 30 of importance in the frames 28 of the video stream 16 and the data rate is lowered in the other areas of the frames 28, to reduce the required bandwidth. The area(s) 30 of importance may need to have their data rate lowered as well, but this will be at a proportionally lower rate, in order to maintain as much of the quality of the area(s) 30 of importance in the video stream 16.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer implemented method comprising:
storing a plurality of client profiles, each client profile defining one or more areas of importance for a frame of a video stream,
transmitting a video stream to a plurality of clients,
determining that a connection to a specific client comprises insufficient bandwidth to transmit the video stream at full resolution,
accessing a client profile for the specific client with a connection of insufficient bandwidth,
reducing a data rate of one or more areas of the frames of the video stream that are not defined as areas of importance for a frame of the video stream in the accessed client profile for the specific client with a connection of insufficient bandwidth, and
transmitting the reduced data rate frames to the specific client with a connection of insufficient bandwidth.

2. A method according to claim 1, wherein the reducing of the data rate of one or more areas of the frames of the video stream that are not defined as areas of importance for a frame of the video stream in the accessed client profile for the specific client with a connection of insufficient bandwidth comprises reducing the data rate to zero in the one or more areas of the frames of the video stream that are not defined as areas of importance for a frame of the video stream in the accessed client profile.

3. A method according to claim 1, and further comprising receiving information defining an area of importance for a frame of the video stream as defined by a client and selecting a client profile for the client according to a best match of the client profile defining one or more areas of importance for a frame of a video stream to the received information defining an area of importance for a frame of the video stream.

4. A method according to claim 1, and further comprising outputting a set of choices, each choice connected to a stored profile, receiving a user input from a specific client selecting a choice from the outputted set of choices and storing an identification of the stored profile connected to the selected choice for the specific client.

5. A method according to claim 1, and further comprising reducing the data rate of one or more areas of the frames of the video stream that are defined as areas of importance for a frame of the video stream in the accessed client profile for the specific client with a connection of insufficient bandwidth.

6. A system comprising:
a storage device arranged to store a plurality of client profiles, each client profile defining one or more areas of importance for a frame of a video stream, and
a processor arranged to:
transmit a video stream to a plurality of clients;
determine that a connection to a specific client comprises insufficient bandwidth to transmit the video stream at full resolution;
access a client profile for the specific client with a connection of insufficient bandwidth;
reduce a data rate of one or more areas of the frames of the video stream that are not defined as areas of importance for a frame of the video stream in the accessed client profile for the specific client with a connection of insufficient bandwidth, and
transmit the reduced data rate frames to the specific client with a connection of insufficient bandwidth.

7. A system according to claim 6, wherein the processor is arranged, when reducing the data rate of one or more areas of the frames of the video stream that are not defined as areas of importance for a frame of the video stream in the accessed client profile for the specific client with a connection of insufficient bandwidth, to reduce the data rate to zero in the one or more areas of the frames of the video stream that are not defined as areas of importance for a frame of the video stream in the accessed client profile.

8. A system according to claim 6, wherein the processor is further arranged to receive information defining an area of importance for a frame of the video stream as defined by a client and selecting a client profile for the client according to a best match of the client profile defining one or more areas of importance for a frame of a video stream to the received information defining an area of importance for a frame of the video stream.

9. A system according to claim 6, wherein the processor is further arranged to output a set of choices, each choice connected to a stored profile, receive a user input from a specific client selecting a choice from the outputted set of choices and store an identification of the stored profile connected to the selected choice for the specific client.

10. A system according to claim 6, wherein the processor is further arranged to reduce the data rate of one or more areas of the frames of the video stream that are defined as areas of importance for a frame of the video stream in the accessed client profile for the specific client with a connection of insufficient bandwidth.

11. A computer program product for controlling a system, the computer program product comprising a computer readable storage medium having program instructions embodied therewith, the program instructions executable by a processor to cause the processor to:
access a plurality of stored client profiles, each client profile defining one or more areas of importance for a frame of a video stream,
transmit a video stream to a plurality of clients,
determine that a connection to a specific client comprises insufficient bandwidth to transmit the video stream at full resolution,
access a client profile for the specific client with a connection of insufficient bandwidth,
reduce a data rate of one or more areas of the frames of the video stream that are not defined as areas of importance for a frame of the video stream in the accessed client profile for the specific client with a connection of insufficient bandwidth, and
transmit the reduced data rate frames to the specific client with a connection of insufficient bandwidth.

12. A computer program product according to claim 11, wherein the instructions for reducing of the data rate of one or more areas of the frames of the video stream that are not defined as areas of importance for a frame of the video stream in the accessed client profile for the specific client with a connection of insufficient bandwidth comprise instructions for reducing the data rate to zero in the one or more areas of the frames of the video stream that are not defined as areas of importance for a frame of the video stream in the accessed client profile.

13. A computer program product according to claim 11, and further comprising instructions for receiving information defining an area of importance for a frame of the video stream as defined by a client and selecting a client profile for the client according to a best match of the client profile defining one or more areas of importance for a frame of a video stream to the received information defining an area of importance for a frame of the video stream.

14. A computer program product according to claim 11, and further comprising instructions for outputting a set of choices, each choice connected to a stored profile, receiving a user input from a specific client selecting a choice from the outputted set of choices and storing an identification of the stored profile connected to the selected choice for the specific client.

15. A computer program product according to claim 11, and further comprising instructions for reducing the data rate of one or more areas of the frames of the video stream that are defined as areas of importance for a frame of the video stream in the accessed client profile for the specific client with a connection of insufficient bandwidth.
